(19) United States
(12) Patent Application Publication
(10) Pub. No.: US 2005/0055709 A1
(43) Pub. Date: Mar. 10, 2005

(54) Cable network access control solution

(76) Inventor: James Alfred Thompson, Houston, TX (US)

Correspondence Address: ROSENTHAL & OSHA L.L.P., Suite 2800, 1221 McKinney Street, Houston, TX, 77010, US

(21) Appl. No.: 10/656,687

(22) Filed: Sep. 5, 2003

(51) Int. Cl. H04N 7/16

(52) U.S. Cl. 725/30; 725/25; 725/6

(57) ABSTRACT

A cable distribution box, including an authentication device obtaining authentication information from an authentication medium, an access administration system operatively connected to the authentication device for verifying the authentication information and collecting work log data, and an access control system operatively connected to the access administration system granting access to the cable distribution box when the authentication information is verified.

### BACKGROUND OF INVENTION

FIG. 1 illustrates a typical cable network infrastructure. The cable network infrastructure includes a Headend (100), which is typically connected by fiber optic cable, microwave, or coaxial cable to a Hub Site (102). Coaxial cable is cable with a solid central conductor surrounded by an insulator, which is in turn surrounded by a cylindrical shield woven from fine wires. It is used to carry high frequency signals such as video, voice, data, or radio. The shield is usually connected to an electrical ground to reduce electrical interference. The Headend (100) is the facility that houses equipment for the reception of satellite signals, off-air broadcast signals, digital and analog transmission equipment, as well as other signal processing/control computers and equipment. Hub sites (102) are facilities where fiber optic or microwave transmission/reception equipment is located to receive signals from the Headend (102) and convert and/or amplify signals so they can be sent through additional fiber optic or coaxial cables to residential or commercial areas.

The signal from the Headend (100) is sent to the Hub site (102) and is subsequently transmitted via fiber optic transmission systems to one or more fiber receive/transmit Hub (104, 106), then in turn an optical signal is converted to an electrical signal for transmission over coaxial cable, often through several signal amplifiers, to one or more cable distribution boxes (CDB) (108, 110). The CDB (108, 110) is often a reinforced box structure with a traditional mechanical locking device. The CDB (108, 110) contains devices known as taps, which connect large coaxial cable to smaller coaxial cables known as drops. The drops carry the electrical signal to each viewing location, e.g., apartment, condo, town home, house, office, etc.

In the case of the multi-dwelling units, (i.e., apartment complexes, condo's, townhouses, offices, etc.), the CDB (108, 110) provide security against theft of cable signals by restricting access to the taps and drop connections leading to each multi-dwelling unit. To access the CDB (108, 110), a service technician must use the appropriate key to unlock the CDB (108, 110). Access to the CDB (108, 110) is not monitored beyond restricting the distribution of the keys to access the CDB (108, 110). Because not all cable signals are encrypted or scrambled (in part due to FCC regulation and in part for marketing reasons), it is possible to steal cable service if one can gain unauthorized access to the CDB (108, 110) and make the simple mechanical drop connection. Because the locking devices on CDB (108, 110) are normally ordinary key-type locks (e.g., padlocks, cylinder locks, etc.), and access to the CDB (108, 110) is not monitored, theft of cable services using duplicated keys or other unauthorized access can occur.

### SUMMARY OF INVENTION

In general, in one aspect, the invention relates to a cable distribution box, comprising an authentication device obtaining authentication information from an authentication medium, an access administration system operatively connected to the authentication device for verifying the authentication information and collecting work log data, and an access control system operatively connected to the access administration system granting access to the cable distribution box when the authentication information is verified.

In general, in one aspect, the invention relates to a cable distribution box, comprising an authentication device obtaining authentication information from an authentication medium, a memory operatively connected to the authentication device comprising verification information and work log data, and an access control system operatively connected to the authentication device and the memory, using the verification information and the authentication information to determine whether to grant access to the cable distribution box.

In general, in one aspect, the invention relates to a method for accessing a cable distribution box, comprising obtaining authentication information from an authentication medium, sending an access request to an access administration system, wherein the access request comprises the authentication information, verifying the access request, generating a work log associated with the access request, and granting access to the cable distribution box if the access request is verified.

In general, in one aspect, the invention relates to an apparatus for accessing a cable distribution box, comprising means for obtaining authentication information from an authentication medium, means for sending an access request to an access administration system, wherein the access request comprises the authentication information, means for verifying the access request, means for generating a work log associated with the access request, and means for granting access to the cable distribution box if the access request is verified.

Other aspects and advantages of the invention will be apparent from the following description and the appended claims.

### BRIEF DESCRIPTION OF DRAWINGS

FIG. 1 illustrates a typical cable network infrastructure.

FIG. 2 illustrates a typical networked computer system.

FIG. 3 illustrates cable network access control system in accordance with one embodiment of the invention.

FIG. 4 illustrates a flowchart in accordance with one embodiment of the invention.

FIG. 5 illustrates a flowchart for authenticating a user in accordance with one embodiment of the invention.

FIG. 6 illustrates a flowchart for continuous monitoring in accordance with one embodiment of the invention.

FIG. 7 illustrates cable network access control system in accordance with one embodiment of the invention.

### DETAILED DESCRIPTION

Specific embodiments of the invention will now be described in detail with reference to the accompanying figures. Like elements in the various figures are denoted by like reference numerals for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

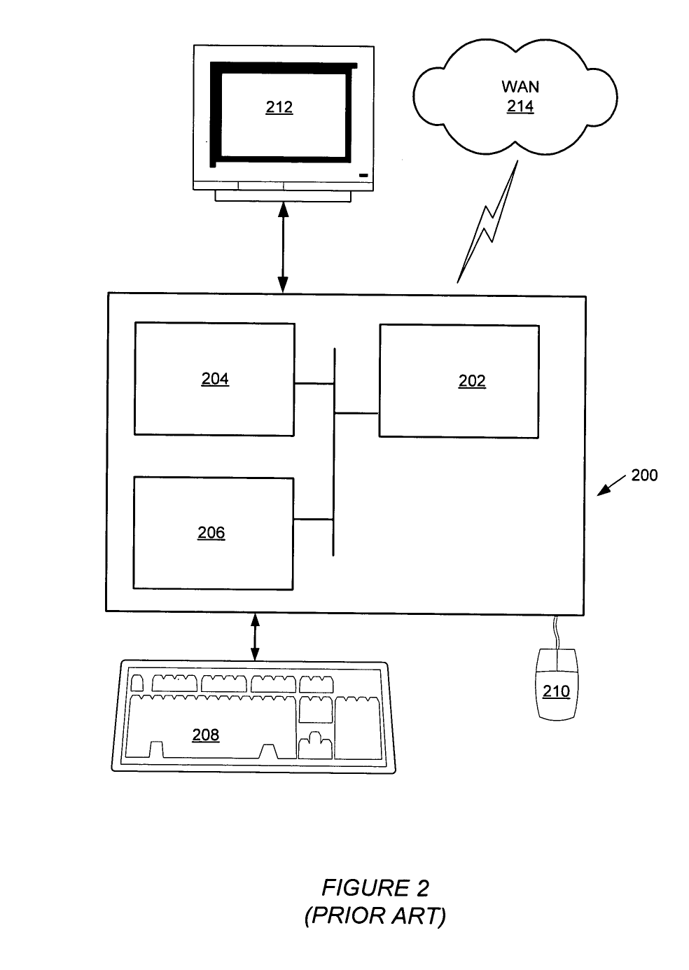

The invention may be implemented on virtually any type computer regardless of the platform being used. For example, as shown in FIG. 2, a typical networked computer system (200) includes a processor (202), associated memory (204), a storage device (206), and numerous other elements and functionalities typical of today's computers (not shown). The networked computer (200) may also include input means, such as a keyboard (208) and a mouse (210), and output means, such as a monitor (212). The networked computer system (200) is connected to a local area network (LAN) or a wide area network (214) (e.g., the Internet) via a network interface connection (not shown). Those skilled in the art will appreciate that these input and output means may take other forms.

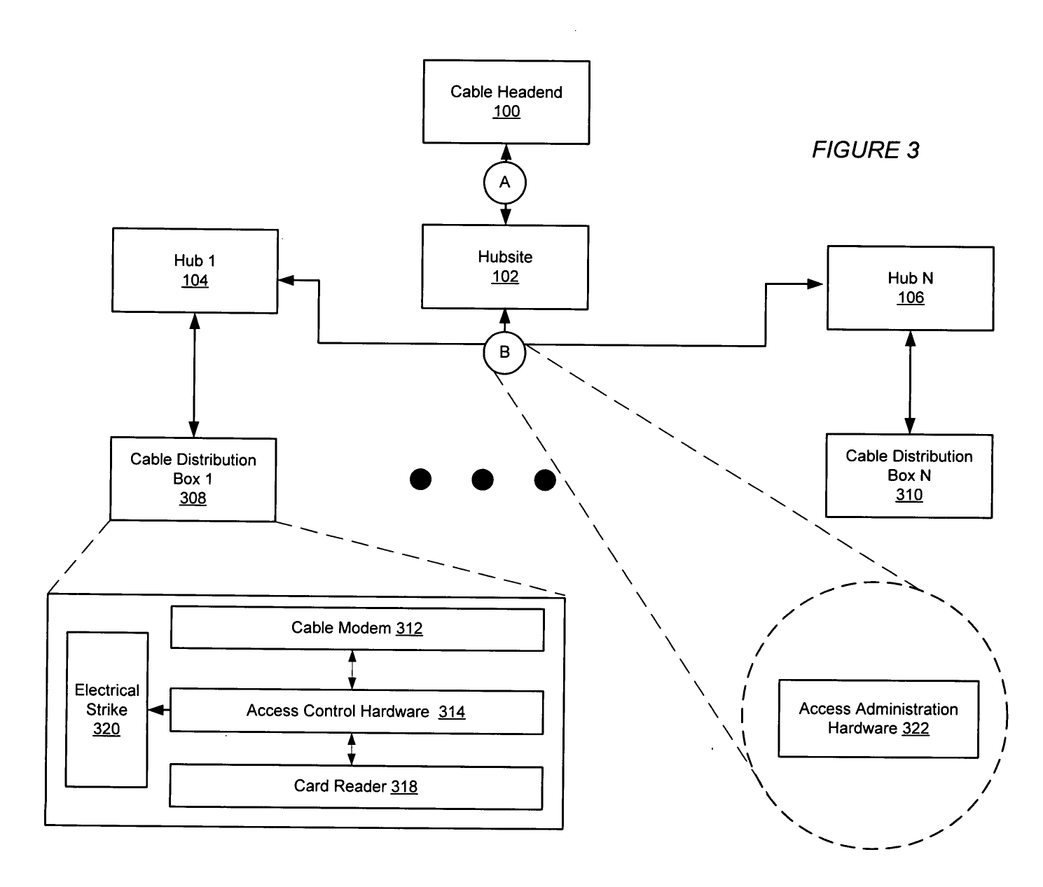

FIG. 3 illustrates cable network access control system in accordance with one or more embodiments of the invention. As noted above, the cable network infrastructure includes a Headend (100), which is typically connected by fiber optic cable, microwave, or coaxial cable to a Hub Site (102). The Headend (100) is the facility that houses equipment for the reception of satellite signals, off-air broadcast signals, digital and analog transmission equipment, as well as other signal processing/control computers and equipment. Hub sites (102) are facilities where fiber optic or microwave transmission/reception equipment is located to receive signals from the Headend (100) and convert and/or amplify signals so they can be sent through additional fiber optic or coaxial cables to residential or commercial areas.

The signal from the Headend (100) is sent to the Hub site (102) and is subsequently transmitted via fiber optic transmission systems to a fiber receive/transmit Hub (104, 106), then in turn an optical signal is converted to an electrical signal for transmission over coaxial cable, often through several signal amplifiers, to CDB (308, 310). The CDB (308, 310) may include, but is not limited to, CDB servicing Multi-Dwelling Units, CDB servicing single dwelling units, CDB servicing commercial real estate, etc.

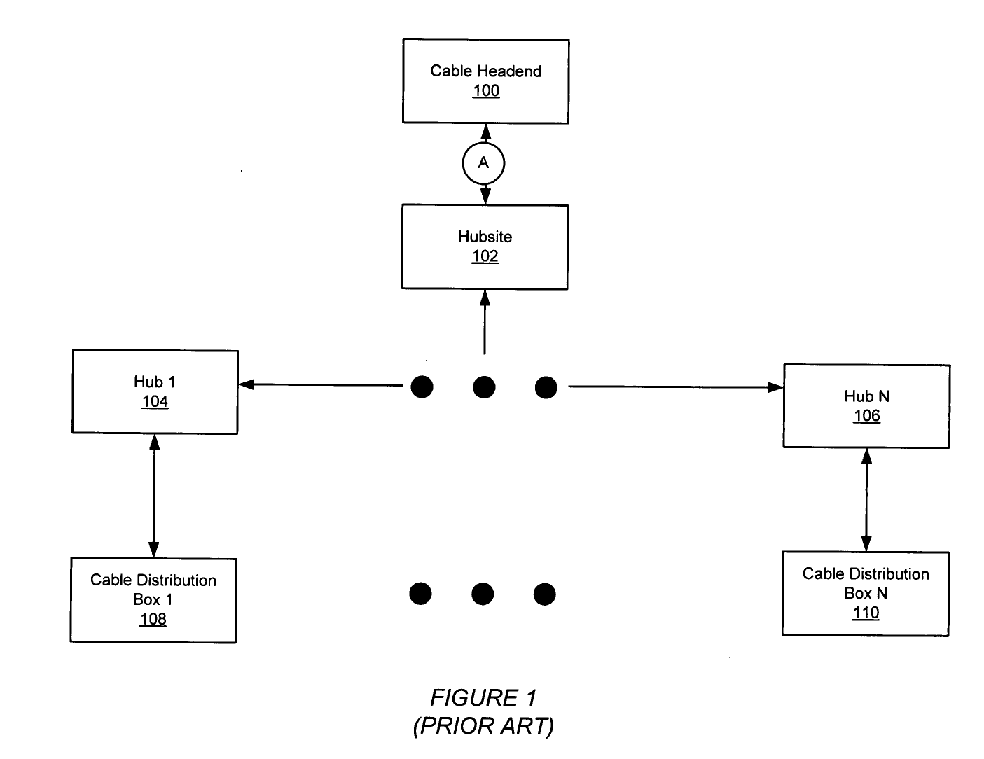

In accordance with one embodiment of the invention, each existing CDB (108 and 110 in FIG. 1) may be retrofitted, or alternatively, each new CDB (308, 310) may be designed such that each modified CDB (308, 310) (i.e., new or retrofitted CDB) includes a cable modem (312), access control hardware (314), which executes an access control program (e.g., access control software, firmware, or a combination thereof, etc.) (not shown), a card reader (318) (e.g., “swipe” or “proximity” card readers typically used to control locks on commercial buildings and hotel room doors), and an electrical strike (320) for electro-magnetically locking the modified CDB (308, 310). The access control hardware (314) and the access control program (not shown), may be collectively referred to as an access control system. The electrical strike may be either a fail-secure or a fail-safe model depending on the design needs of the modified CDB (308, 310). In one embodiment of the invention, all components within the modified CDB (308, 310) are powered using current obtained from the existing cable TV system. In addition, the CDB (308, 310) may also include a back-up battery (not shown) such as a trickle-charge battery. The back-up battery may be used to reduce the impact of sudden spikes in power consumption by the CDB (308, 310).

Those skilled in the art will appreciate that while the CDB in the present invention is secured using an electrical strike, other types of locking devices may be used to secure the CDB. For example, the CDB may be secured by an electromagnetic lock, a mechanical bolt designed to lock and unlock the CDB based on an electrical signal from the access control system, etc.

In addition, though not shown, the modified CDB (308, 310) may also include a cache memory to temporarily store access card permissions allowing the security of the CDB to remain functional in the event that the access administration hardware (322) or the access administration program (not shown) executing on the access administration hardware (322) are not responding to an authentication request. Further, the modified CDB (308, 310) may also include a diagnostics port. In one embodiment of the invention, a unique ID is associated with each modified CDB (308, 310).

The cable modem (312), e.g., DOCSIS (Data Over Cable Service Interface Specification) type, is used to communicate, using standard Internet Protocol (IP) communications techniques, with the access administration program (e.g., access administration software, firmware, or a combination thereof, etc.) (not shown), which executes on the access administration hardware (322) located in the cable network infrastructure. The access administration hardware (322) and the access administration program (not shown) may be collectively referred to as an access administration system. The cable modem (312) also enables communication between the card reader (318) and the access administration system. The cable modem (312) communicates via the bi-directional data channels established through the coaxial cable network used by the cable company to deliver cable television signals to its customers.

The access control hardware (314) may include a processor, memory (RAM and/or ROM), and a storage medium, such as a cache memory or a hard drive. The access control system also includes functionality to create, store, and upload work logs, as well as functionality to download updated lists of enabled or disabled access cards. The work log, maintained in real-time or as a historic accounting, may include, but is not limited to, what access card was used, who was authorized to use it, when it was used (i.e., date, time, etc.), the duration of use, what taps were serviced, the location of use, etc. Further, the access control system includes functionality to interface with the access administration system, via the cable modem (312).

The access control system also interfaces with the card reader (318). The card reader (318) may be a proximity card reader, a swipe card reader, a finger print reader, an eye print reader, a voice recognition device, or any other device (i.e., an authentication device) capable of obtaining authentication information from an authentication medium (e.g., a swipe card, a proximity card, a finger print, a voice, etc.). In one embodiment of the invention, the card reader (318) is used to read access cards. Each access card may include authentication information as well as other information necessary to identify the cardholder (e.g., the service technician). Further, depending on the amount of available memory on the access card, the access card may store a work log or any other additional information maintained by the access control system or the access administration system.

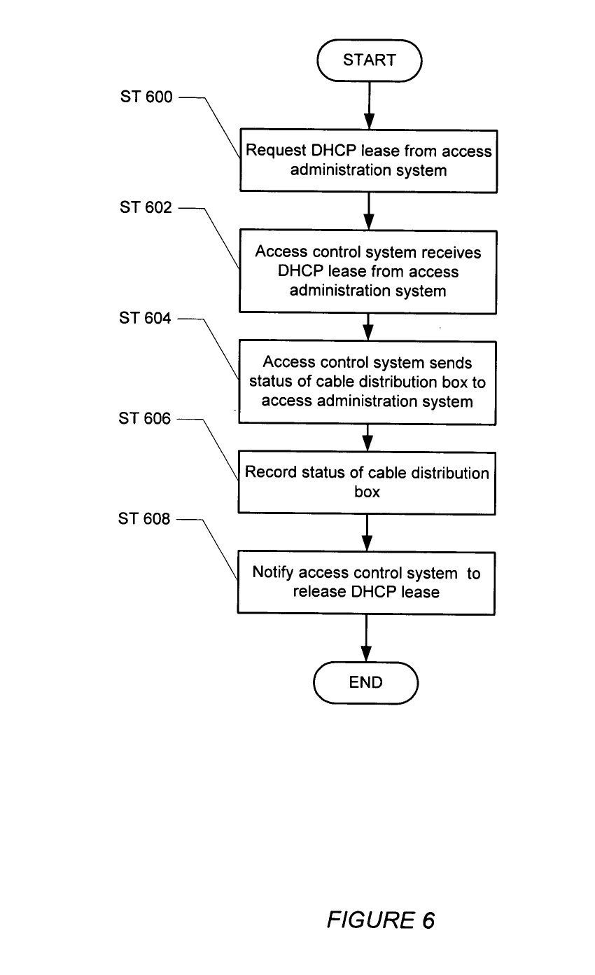

Though not shown in FIG. 3, the CDB (308, 310) may also include an open door sensor, such as a photo-transistor, connected to the access control system thereby allowing the access control system and/or access administration system to monitor when the CDB is open or closed. In addition, the CDB (308, 310) may also include a tamper switch connected to the access control system allowing the access control system and/or the access administration system to determine whether and at what time a particular CDB has been tampered with. The tamper switch may be used in conjunction with the status functionality described below in FIG. 6.

The access administration system may be located anywhere within the cable network infrastructure. For example, while the access administration system is shown at point B in FIG. 3, other locations may include the Headend (100), at the Hub site (102), at point A, etc. Further, the access administration system may also be located outside the cable network infrastructure and communicate a LAN or a WAN, via the cable modem (or the particular communication device used to enable communication between the access control system and the access administration system).

Additionally, for increased performance, multiple access administration systems may exist within the cable network infrastructure. The access administration system may also include functionality to verify authentication information, analyze work logs (manually or automatically), send alerts to administrators indicating potential theft, enable and disable individual access cards, track access card usage, provide a database of historical information on access card usage that enables the users to write and obtain reports, etc. In one embodiment of the invention, the access administration system verifies the authentication information using verification information such as a list of enabled access cards, a list of disabled access cards, or any information that may be used to verify the authentication information obtained from the authentication medium.

Additionally, the access administration program may have one or more of the following features: access restriction to prevent unauthorized users from accessing the access administration program; encryption functionality (i.e., symmetric, public key-private key encryption, etc.) to encrypt and decrypt messages sent between the access control systems and the access administration systems in the cable network infrastructure; functionality to indicate whether a CDB has been improperly accessed (e.g., using an indicator light on the CDB, etc.); functionality to remotely enable/disable an access card; functionality to remotely open a particular CDB in the event that the card reader is malfunctioning; and functionality to reset a particular CDB if the access control program is not responding.

Those skilled in the art will appreciate that while the present invention uses a cable modem to enable communication between the access control system and the access administration system, communication between the access control system and the access administration system is not limited to cable modems. Thus, depending on the implementation, communication between the access control system and the access administration system may be enabled by a conventional telephone modem, a non-DOCSIS modem, etc.

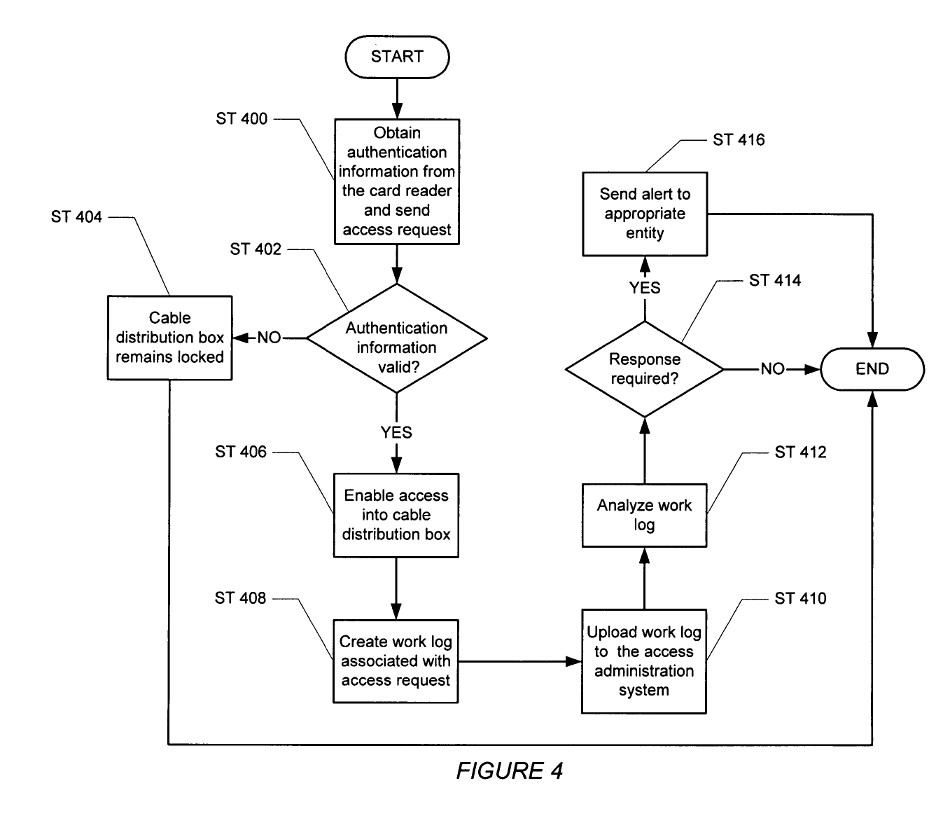

FIG. 4 illustrates a flowchart in accordance with one or more embodiments of the invention. Initially, authentication information is obtained from an access card via a card reader associated with a CDB and an access request is sent to the access control system (Step 400). In one embodiment of the invention, the access request includes authentication information (such as a user ID and associated user password), and a CDB identification number that uniquely identifies the CDB. Those skilled in the art will appreciate that if an alternative authentication mechanism is used such as a fingerprint reader, then an access card may not be required for authentication. Further, those skilled in the art will appreciate that added security may result by including password information or public/private key information on the access card.

The authentication information is then compared to a list of enabled access cards and/or a list of disabled access cards to determine whether the obtained authentication information is valid (Step 402). The list of enabled and/or disabled access cards may be stored locally at the CDB or remotely on the access administration hardware. If the authentication information is not valid, then the CDB remains locked (Step 404). If the authentication information is valid, then the cardholder obtains access to the CDB (Step 406). Each attempt to access the CDB is recorded by the access control system.

Once the cardholder has gained access to the CDB, a work log, as described above, is created that is associated with the access request of the cardholder (Step 408). Upon closing of the CDB (or alternatively, in real-time), the work log is uploaded to the access administration system (Step 410). Depending on the implementation architecture of the access control system, the work log, and any additional information (e.g., the enabled list and/or disabled list) may be “pushed” or “pulled” between the access control system and the access administration system.

The work log is subsequently analyzed (Step 412). The analysis may include real-time analysis, automatic analysis, manual analysis, or any combination thereof. The analysis may include review of usage patterns, unauthorized access, unauthorized service, billing reports, etc. Based on the analysis, a determination is made as to whether a response is required (Step 414). The response may include, but is not limited to, disabling an access card, updating the enabled access card list and/or the disabled access card list, notifying the authorities that cable theft is occurring, generating an invoice, generating an efficiency report, etc. If a response is required, then an alert is sent to the appropriate entity (Step 416). Otherwise, if a response is not required, then the work log is stored and no additional action is taken.

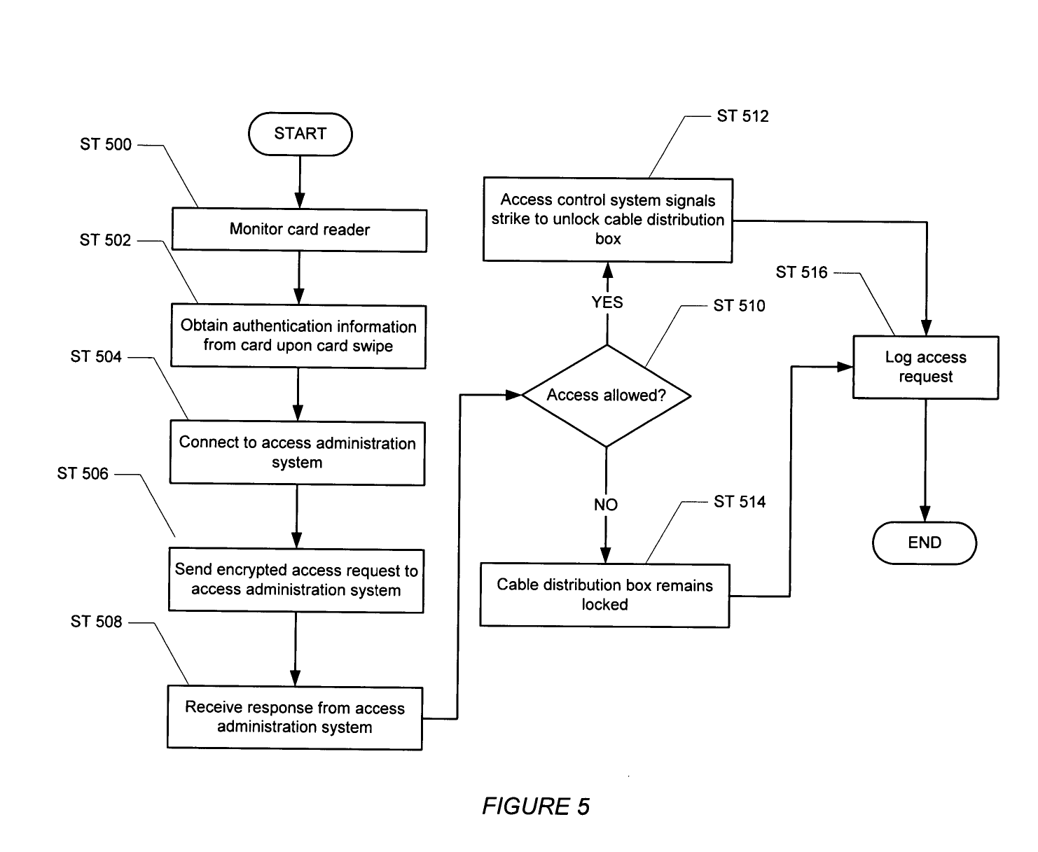

FIG. 5 illustrates a flowchart for authenticating a user in accordance with one embodiment of the invention. During normal operation, the access control hardware (314 in FIG. 3) monitors the card reader (500). Once an access card has been “swiped,” the information obtained from the access card is sent, via the card reader (318 in FIG. 3), to the access control hardware (314 in FIG. 3) (Step 502). In one embodiment of the invention, the information obtained from the access card may include, but is not limited to, the access cardholder's name, employee number, unique access key, an algorithm for generating a response to a challenge request, etc.

The access control system subsequently connects to the access administration system (Step 504). Once connected, the access control system sends an encrypted access request to the access administration system (Step 506). In one embodiment of the invention, the access request includes authentication information (such as a user ID and associated user password), and a CDB identification number that uniquely identifies the CDB. A response is subsequently sent from the access administration system back to the access control system (Step 508). The access control system then evaluates the response to determine whether to grant access (Step 510). If access is granted, then the access control system via the access control hardware (314 in FIG. 3) signals the strike to open the modified CDB (308 and 310 in FIG. 3) by sending an electrical impulse to the strike (Step 512). However, if access is denied then the CDB remains locked (Step 514). Simultaneously, regardless of whether access is granted or denied, the access request is logged by the access control system (Step 516).

Those skilled in the art will appreciate that the access request may be logged at anytime or numerous times during the authentication process. Further, those skilled in the art will appreciate that the request-response authentication method disclosed in FIG. 5 may be modified to include a challenge-response authentication process where upon receiving an access request, the access administration program replies with a challenge string prompting the access control program, using information obtained from the access card, to respond to the challenge. In addition, the other authentication methods that use one-time passwords, etc., may be used to authenticate the cardholder.

In one embodiment of the invention, each authentication medium (e.g., access card) is assigned to one or more logical groups. Each group includes one or more zones, each of which includes one or more cable distribution boxes. The aforementioned access model allows a system administrator to assign a particular card the access privileges of a particular group or groups, rather than having to identify each CDB that a particular access card can access. However, the aforementioned access model retains the functionality to allow the system administrator to specify, at the CDB level, which CDB may be accessed, etc. Those skilled in the art will appreciate that the granularity of access specificity is conditioned upon the individual access policies the system administrator(s) wish to implement and/or maintain.

FIG. 6 illustrates a flowchart for continuous monitoring in accordance with one embodiment of the invention. In one embodiment of the invention, during normal operation, the access control system constantly monitors the status of the modified CDB (308 and 310 in FIG. 3). Periodically, for example, at one-hour intervals, the access control system requests a Dynamic Host Configuration Protocol (DHCP) lease from the access administration system (Step 600). The DHCP lease corresponds to a dynamically assigned IP address that is used by the access control system to communicate with the access administration system. The access administration system responds by sending a DHCP lease to the access control system (Step 602). The access control system polls various access control hardware components and various access control program components to determine the status of this particular CDB and subsequently sends the status to the access administration system (Step 604). Examples of status include open, closed, malfunctioning, etc. The status is then recorded by the access administration system (Step 606). The access control system then notifies the access administration system to release the DHCP lease (Step 608).

In one embodiment of the invention, the CDB includes a visual status indicator such as a status light/diode. Thus, while the status of the CDB is active, as determined by the access control system, the status light/diode, for example, may be green. However, if the status of the CDB is inactive, as determined by the access control system, the status light/diode, for example, may turn red. Terms “active” and “inactive” are relative terms used to indicate whether the access control system for a particular CDB is operating normally or the access control system for the particular CDB is operating incorrectly or malfunctioning.

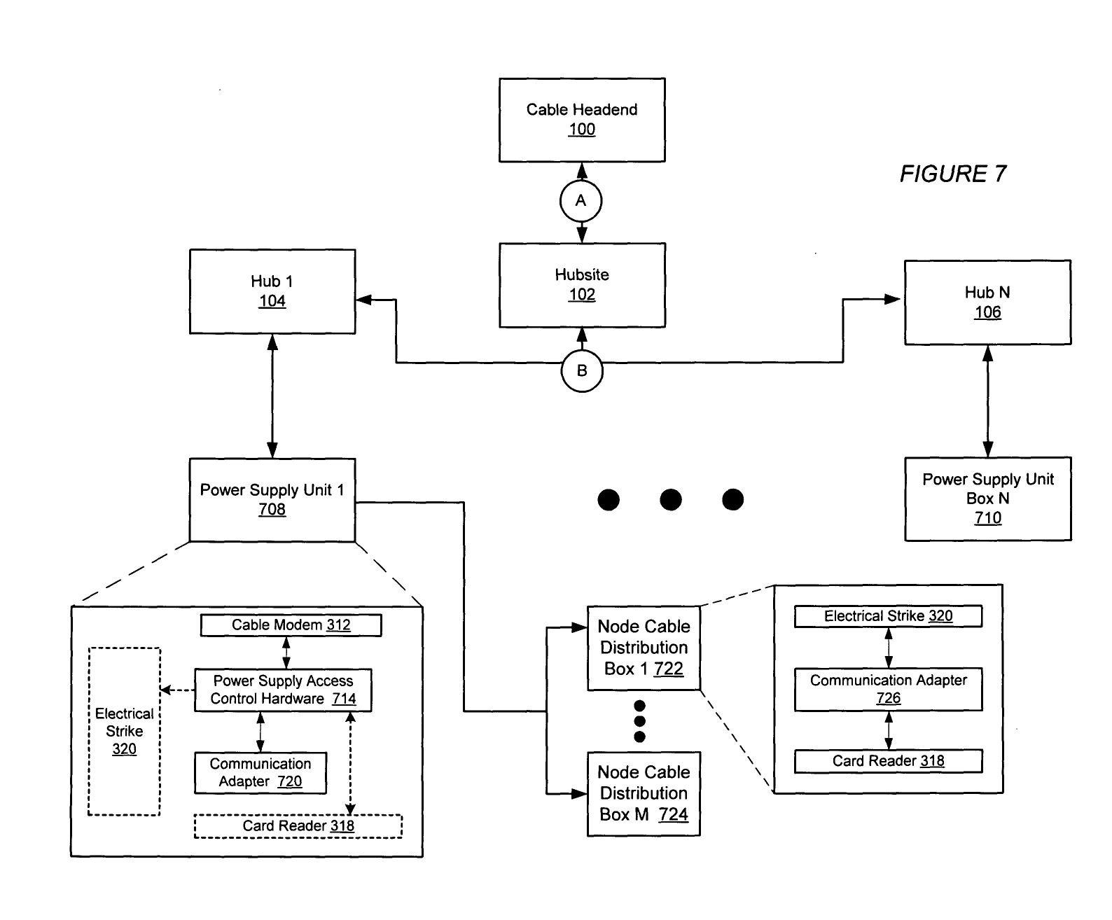

FIG. 7 illustrates cable network access control system in accordance with another embodiment of the invention. As noted above, the cable network infrastructure includes a Headend (100), which is typically connected by fiber optic cable, microwave, or coaxial cable to a Hub Site (102). The signal from the Headend (100) is sent to the Hub site (102) and is subsequently transmitted via fiber optic transmission systems to a fiber receive/transmit hub (104, 106), then in turn an optical signal is converted to an electrical signal for transmission over coaxial cable, often through several signal amplifiers, to Power Supply Units (“PSU”) (708, 710). The PSU (708, 710) operates to handle communication between the access administration hardware (not shown) and the Node Cable Distribution Boxes (NCDB) (722, 724). A single PSU (708, 710) may support any number of NCDB (722, 724).

In accordance with one embodiment of the invention, each existing CDB (108 and 110 in FIG. 1) may be retrofitted, or alternatively, a new CDB may be designed and connected to the cable network such that the resulting CDB is configured as either PSU (708, 710) or NCDB (722, 724). Further, the resulting PSU (708, 710) and the NCDB (722, 724) are arranged within the cable network such that each PSU (708, 710) in the cable network is connected to a number of NCDB (722, 724).

Each PSU (708, 710) includes a cable modem (312), power supply (“PS”) access control hardware (714), which executes a PS access control program (e.g., PS access control software, PS firmware, or a combination thereof, etc.) (not shown) and a communication adapter (720). In addition, depending on the implementation of the PSU (708, 710), the PSU (708, 710) may also include a card reader (318) (e.g., “swipe” or “proximity” card readers typically used to control locks on commercial buildings and hotel room doors), and an electrical strike (320) for electro-magnetically locking the PSU (708, 710), as described above with respect to FIG. 3. The PS access control hardware (714) and the PS access control program (not shown) may be collectively referred to as a PS access control system.

The PSU access control system typically includes the same functionality as the access control system described above. In addition, the PSU access control system includes functionality to provide an interface between the NCDB (722, 724) and the access control hardware (not shown). Specifically, the PSU access control system may include functionality to manage multiple/concurrent access requests from the NCDB and any other related functionality required to control communications between the administration control system and the NCDB (722, 724).

In one embodiment of the invention, all components within the PSU (708, 710) are powered using current obtained from a transformer or similar powering circuitry via the coaxial cable. In addition, the PSU (708, 710) may also include a back-up battery (not shown) such as a trickle-charge battery. The back-up battery may be used to reduce the impact of sudden spikes in power consumption by the PSU (708, 710).

The communication adapter (720) is used as a communication interface between the PSU (708, 710) and the associated NCDB (722, 724). By using a communication adapter (720, 726) to communicate between the PSU (708, 710) and the NCDB (722, 724), a cable modem (with its associated power requirements) is no longer required to be in each retrofitted or new NCDB. As a back-up measure, a given communication adapter (726) in a NCDB (722, 724) may be configured to communicate with more than one PSU (708, 710), such that the NCDB (708, 710) may continue to operate using a back-up PSU (708, 710) when the primary PSU (708, 710) used by the NCDB (722, 724) is malfunctioning, broken, etc.

In one embodiment of the invention, the communication adapter (720) includes a Radio Frequency (“RF”) tuner, an associated demodulator, a media access controller (“MAC”), an associated modulator, and a cable data converter (“CDC”). The RF tuner is used to “listen” to a specific radio frequency range. The demodulator is used to extract information from the signal received by the RF tuner, which is subsequently sent to the MAC. The modulator is used to convert signals from the MAC to the signals that can be transmitted on the co-axial cable. The MAC is a networking core used to provide communication functions such as signal collision detection, signal re-transmission, ranging, and addressing. The CDC is used to interface the communication adapter (720) with the other components in the PSU (708, 710), such as the PS access control hardware (714). In some embodiments of the invention, the communication adapter (720) may be based on proprietary cable based RF technology, or alternatively, the communication adapter (720) may be based on cable modem chipsets.

Those skilled in the art will appreciate that while the communication adapter (720, 726) has been described as communicating over the existing cable infrastructure, the communication adapter (720, 726) may be any communication device that allows the communication adapters (720, 726) in the various NCDB (722, 724) and the PSU (708, 710) to communicate with one another, e.g., wireless, peer-to-peer, etc.

Returning to FIG. 7, in one embodiment of the invention each NCDB (722, 724) connected to the PSU (708, 710) includes a communication adapter (726), an electrical strike (320) and a card reader (318). The communication adapter (726) in the NCDB (722, 724) includes the same components as the communication adapter (720) in the PSU (708, 710) but may also include NCDB access software, firmware, or a combination thereof (“the NCDB program”). The NCDB program typically includes the same functionality as the access control system, as described above. However, an additional micro-controller may be provided to execute the NCDB program.

Alternatively, the communication adapter (726) may be configured to only act as an interface between the components on the NCDB (722, 724) (i.e., the card reader (318) and the electrical strike (320)) while all other functionality and processing is carried out by the associated PSU (708, 710). This type of topology is analogous to having a series of terminals, acting as input/output devices, connected to a backend processor.

Those skilled in the art will appreciate that while the PSU and the NCDB in the present invention may be secured using an electrical strike, other types of locking devices may be used to secure the PSU and/or the NCDB. For example, the PSU and/or the NCDB may be secured by an electromagnetic lock, a mechanical bolt designed to lock and unlock the PSU and the NCDB based on an electrical signal from the access control system, etc.

In addition, though not shown, the PSU (708, 710) may also include a cache memory to temporarily store access card permissions allowing the security of the PSU (708, 710) and the associated NCDB (722, 724) to remain functional in the event that the access administration hardware (322) or the access administration program (not shown) executing on the access administration hardware (322) are not responding to an authentication request. Further, the PSU (708, 710) and the NCDB (722, 724) may also include diagnostics ports. In one embodiment of the invention, a unique ID is associated with each PSU (708, 710) and NCDB (722, 724).

The cable modem (312), e.g., DOCSIS (Data Over Cable Service Interface Specification) type, is used by the PSU (708, 710) to communicate, using standard Internet Protocol (IP) communications techniques, with the access administration program (e.g., access administration software, firmware, or a combination thereof, etc.) (not shown), which executes on the access administration hardware (not shown) located in the cable network infrastructure.

Though not shown in FIG. 7, each PSU (708, 710) and NCDB (722, 724) may also include an open door sensor, such as a photo-transistor, connected to the access control system thereby allowing the access control system and/or access administration system to monitor when a particular PSU (708, 710) or NCDB (722, 724) is open or closed. In addition, each PSU (708, 710) and NCDB (722, 724) may also include a tamper switch connected to the access control system allowing the access control system and/or the access administration system to determine whether and at what time a particular CDB has been tampered with. The tamper switch may be used in conjunction with the status functionality described above in FIG. 6.

Those skilled in the art will appreciate that the functionality described in FIGS. 4-6 may be extended and modified as necessary, to execute on the embodiment shown in FIG. 7. In addition, the administration control system referenced in the discussion of FIG. 7 includes the same functionality as the administration control system described above.

Those skilled in the art will appreciate that while the PSU described in FIG. 7 handles communication between a number of NCDB and the access administration program, the PSU may also include functionality to operate as an NCDB. In this manner, each PSU and NCDB can be used to secure a CDB, as opposed to only having the NCDB secure a CDB while the PSU is managing the communication functionality.

Those skilled in the art will appreciate that while the invention has been described using cable access administration hardware executing a cable access administration program, the invention may be implemented using any type of verification device that includes functionality to verify the authentication information.

The invention may have one or more of the following advantages. A system is provided to secure the current cable network infrastructure. The system allows a cable company to secure cable distribution boxes, control access to the cable distribution boxes, and to remotely monitor the cable distribution boxes. Embodiments of the present invention provide means for creating an access system for cable distribution boxes requiring minimal modification to the existing cable network infrastructure (i.e., by modifying existing cable distribution boxes to include the access control component powered by the existing cable transmission line).

Embodiments of the present invention provide means for decreasing the theft of cable services by reducing unauthorized access to the CDB and deterring theft of cable services by monitoring access to CDB. Further, embodiments of the present invention provide a logging function to allow a cable company or system user to log activity for each CDB. Further, the logging function may be easily customized to meet the needs of a specific cable company. The logging function also allows the cable company or system user to perform data mining on the logged data to ascertain the quality of work of its various service technicians. In addition, embodiments of the present invention reduce, and, in some cases, may eliminate the need for the cable company to routinely audit or physically check the drop connections in CDB. Embodiments of the present invention may also reduce the cost of maintenance and repair of CDB by rapidly identifying cable distribution boxes that have been tampered with or are damaged, thereby allowing the cable company to quickly respond. Embodiments of the present invention, may include various configurations for the CDB to accommodate the various power and cost constraints a particular cable network infrastructure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A cable distribution box, comprising:
an authentication device obtaining authentication information from an authentication medium; and
an access control system operatively connected to an access administration system granting access to the cable distribution box when the authentication information is verified,
wherein the access administration system operatively connected to the authentication device for verifying the authentication information and collecting work log data.

2. The cable distribution box of claim 1, further comprising:
a lock operatively connected to the access control system unlocking the cable distribution box when access to the cable distribution box has been granted.

3. The cable distribution box of claim 1, further comprising:
a communication device operatively connected to the access control system providing communication services between the access control system and the access administration system.

4. The cable distribution box of claim 1, wherein the communication device is at least one selected from the group consisting of a communication adapter and a cable modem.

5. The cable distribution box of claim 1, wherein the access administration system comprises at least one selected from the group consisting of access administration hardware, access administration software, and firmware.

6. The cable distribution box of claim 1, wherein the access control system comprises at least one selected from the group consisting of access control software, access control hardware, and firmware.

7. The cable distribution box of claim 1, wherein the authentication device is a card reader and the authentication medium is an access card.

8. The cable distribution box of claim 7, wherein the access administration system includes functionality to disable the access card.

9. The cable distribution box of claim 1, wherein the access administration system collects the authentication information.

10. The cable distribution box of claim 1, wherein the access administration system generates a work log from the authentication information and the work log data.

11. The cable distribution box of claim 10, wherein the access administration system includes functionality to analyze the work log to determine whether a response is required and functionality to send an alert to an appropriate entity if the response is required.

12. The cable distribution box of claim 1, wherein the access administration system verifies the authentication information using a request-response authentication method.

13. The cable distribution box of claim 1, wherein the access administration system verifies the authentication information using a challenge-response authentication method.

14. The cable distribution box of claim 1, wherein communication between the authentication device and the access control system is encrypted.

15. The cable distribution box of claim 1, wherein communication between the access administration system and the access control system is encrypted.

16. The cable distribution box of claim 1, wherein the authentication device, the access administration system, and the access control system are powered using current obtained from a cable line operatively connected to the cable distribution box.

17. The cable distribution box of claim 2, wherein the lock is powered using current obtained from a cable line operatively connected to the cable distribution box.

18. The cable distribution box of claim 3, wherein the communication device is powered using current obtained from a cable line operatively connected to the cable distribution box.

19. A cable distribution box, comprising:
an authentication device obtaining authentication information from an authentication medium;
a memory operatively connected to the authentication device comprising verification information and work log data; and
an access control system operatively connected to the authentication device and the memory, using the verification information and the authentication information to determine whether to grant access to the cable distribution box.

20. The cable distribution box of claim 19, further comprising:
a lock operatively connected to the access control system for unlocking the cable distribution box when access to the cable distribution box has been granted.

21. The cable distribution box of claim 19, wherein the authentication device is a card reader and the authentication medium is an access card.

22. The cable distribution box of claim 19, wherein the access control system collects the authentication information.

23. The cable distribution box of claim 22, wherein the access control system generates a work log from the authentication information and the work log data.

24. The cable distribution box of claim 23, wherein the access control system includes functionality to analyze the work log to determine whether a response is required and functionality to send an alert to an appropriate entity if the response is required.

25. The cable distribution box of claim 19, wherein the access control system verifies the authentication information using a request-response authentication method.

26. The cable distribution box of claim 19, wherein the access control system verifies the authentication information using a challenge-response authentication method.

27. The cable distribution box of claim 19, wherein communication between the authentication device and the access control system is encrypted.

28. The cable distribution box of claim 19, wherein the authentication device, the memory, and the access control system are powered using current obtained from a cable line operatively connected to the cable distribution box.

29. The cable distribution box of claim 20, wherein the lock is powered using current obtained from a cable line operatively connected to the cable distribution box.

30. A method for accessing a cable distribution box, comprising:
obtaining authentication information from an authentication medium;
sending an access request to an access administration system, wherein the access request comprises the authentication information;
verifying the access request;
generating a work log associated with the access request; and
granting access to the cable distribution box if the access request is verified.

31. The method of claim 30, further comprising:
uploading the work log to the access administration system;
analyzing the work log to determine whether a response is required; and
sending an alert to an appropriate entity if the response is required.

32. The method of claim 30, further comprising:
continuously monitoring the cable distribution box to determine the status.

33. The method of claim 30, further comprising:
unlocking the cable distribution box when access has been granted.

34. The method of claim 30, wherein the access request is encrypted.

35. The method of claim 30, wherein the access administration system comprises at least one selected from the group consisting of access administration hardware, access administration software, and firmware.

36. The method of claim 30, wherein access to the cable distribution box is granted by an access control system.

37. The method of claim 36, wherein the access control system comprises at least one selected from the group consisting of access control software, access control hardware, and firmware.

38. The method of claim 36, wherein the access administration system, and the access control system are powered using current obtained from a cable line operatively connected to the cable distribution box.

39. An apparatus for accessing a cable distribution box, comprising:
means for obtaining authentication information from an authentication medium;
means for sending an access request to an access administration system, wherein the access request comprises the authentication information;
means for verifying the access request;
means for generating a work log associated with the access request; and
means for granting access to the cable distribution box if the access request is verified.
